(19) United States
(12) Patent Application Publication
(10) Pub. No.: US 2025/0344662 A1
(43) Pub. Date: Nov. 13, 2025

(54) CONFIGURATION SYSTEM FOR A MILKING PLANT MONITORING SYSTEM, COMPUTER-IMPLEMENTED METHOD, COMPUTER PROGRAM AND NON-VOLATILE DATA CARRIER

(71) Applicant: DELAVAL HOLDING AB, Tumba (SE)

(72) Inventor: Erik LUNDKVIST, Tumba (SE)

(21) Appl. No.: 18/867,378

(22) PCT Filed: May 16, 2023
(86) PCT No.: PCT/SE2023/050478

§ 371 Date: Nov. 19, 2024

(30) Foreign Application Priority Data
May 20, 2022 (SE) 2250605-9

(51) Int. Cl. A01J 5/01; G06F 8/65

(52) U.S. Cl. CPC A01J 5/01; G06F 8/65

(57) ABSTRACT

Fluid pressure sensors are operatively connected to respective programmable controllers. A first server receives an instruction message from a user terminal. The instruction message designates identity data of the controllers and an indication of a functioning role that each controller performs. In a first functioning role, the controller is programmed to control a fluid pressure sensor monitoring a pulsation pressure level. In a second functioning role the controller is programmed to control a fluid pressure sensor monitoring a milking pressure level. At a farm with a milking plant monitoring system, a second server communicates with the controllers. Responsive to receiving the instruction message, the first server transmits a configuration message to the second server. The configuration message indicates the specific role that each controller shall attain. The second server transmits respective programming messages to each controller causing the controllers to attain the specific role indicated by the configuration message.

### TECHNICAL FIELD

The present invention relates generally to configuration of milking plants. Especially, the invention relates to a configuration system for a milking plant monitoring system according to the preamble of claim 1 and a corresponding computer-implemented method. The invention also relates to a computer program and a non-volatile data carrier storing such a computer program.

### BACKGROUND

Today's milking systems are highly complex installations in which a multitude of components and pieces of equipment must interact according to a number of well-tuned processes. For optimal operation, it is key that the fluid pressure sensors in the milking system are adequately configured. To effect this configuration, service personnel must spend considerable time onsite at the firm where the milking installation is located.

WO 2020/251456 shows a control unit and configuration tag of a milk analysis apparatus that includes a first wireless communication device for communication with a memory device of the configuration tag. The configuration tag is applicable to the milk analysis apparatus and comprises a reference sign of a milk extracting arrangement to which the milk analysis apparatus is intended to work in conjunction with. The communication is made via a second wireless communication device comprised in the configuration tag. The control unit is configured to retrieve configuration data, e.g. a network location reference such as an IP address, of the milk extracting arrangement that the milk analysis apparatus is intended to operate in conjunction with, from the memory device of the configuration tag via the first wireless communication device; and to configure the control unit, based on the retrieved configuration data of the milk extracting arrangement.

EP 2 840 887 describes a method for controlling devices within an agricultural network system via a network bus such as a physical network bus or a logical network bus, wherein the devices are controlled by means of control information which is transmitted to the devices by means of messages comprising a content and a header title. The method involves: determining a function for performing thereof by a device in the network, determining the content of a message to be transmitted, and compiling header title information for inclusion thereof in a header title for the message to be transmitted. The header title information contains a predetermined number of data fields, such as preferably a network identifier, a device type designation, a function designation, a location designation and/or a group designation, for the purpose of determining on the basis of compliance with one or more of these data fields which device or devices receive(s) the message.

U.S. Pat. No. 7,174,848 shows a controller for monitoring and controlling an operating pulsator in a milking system is shown. The controller comprises a first sensor operatively connected to a designated pulsator for receiving a pulsating vacuum therefrom. The controller produces a first signal representing the pulsating vacuum level. A processor is operatively connected to the first sensor for receiving the first signal. The processor includes a comparator for comparing the first signal to a stored reference signal representing a predetermined vacuum range of pulsating vacuum levels programmed as acceptable for milking systems pulsators. The processor generates at least one control signal when the designated pulsator pulsating vacuum level is at a vacuum level outside of the predetermined vacuum range. A control circuit signals that the designated pulsator pulsating vacuum level is outside the range of pulsating vacuum levels programmed as acceptable for the milking system pulsators.

Thus there exist solutions for adapting and programming agricultural systems, such as the pulsator controllers of a milking system. However, there is yet no convenient means of configuring the fluid pressure sensors of a milking plant monitoring system from a remote location.

### SUMMARY

The object of the present invention is therefore to offer a solution that enables remote configuration of the controllers for the fluid pressure sensors in a milking plant monitoring system.

According to one aspect of the invention, the object is achieved by a configuration system for a milking plant monitoring system including at least one fluid pressure sensor and at least one respective controller that is programmable and operatively connected to the at least one fluid pressure sensor and configured to control the at least one fluid pressure sensor. The configuration system contains a first server and a second server. The first server is configured to receive an instruction message from at least one user terminal. The instruction message designates identity data of at least one of the at least one controller and an indication of a specific functioning role of at least two different functioning roles that each of the at least one of the at least one controller shall attain. The at least two different functioning roles include a first functioning role wherein the controller is programmed to control a fluid pressure sensor monitoring a pulsation pressure level, and a second functioning role wherein the controller is programmed to control a fluid pressure sensor monitoring a milking pressure level. The second server is communicatively connected to the first server. The second server is arranged at a farm where the milking plant monitoring system is located. The second server is further configured to communicate with the at least one controller. In response to receiving the instruction message, the first server is configured to transmit a configuration message to the second server. The configuration message contains a listing that for each of at least one of the at least one controller indicates the specific role that the controller shall attain. In response to the configuration message, the second server is configured to transmit a respective programming message to each of the at least one of the at least one controller comprised in said listing. The programming message, in turn, is configured to cause each of the at least one of the at least one controller to attain the specific role indicated by said listing.

This configuration system is advantageous because it allows a user to set up the key functionalities of a milking plant's fluid pressure sensors from a remote location.

The first functioning role may involve monitoring the pulsation pressure level in a pulsator in at least one milking point in a milking system at the farm. Further, the second functioning role may involve monitoring the milking pressure level in the at least one milking point of the milking system at the farm.

According to one embodiment of this aspect of the invention, the two different functioning roles further include a third functioning role wherein the controller is programmed to control a fluid pressure sensor monitoring a pressure level at a first point in a milk line arranged to transport milk from a set of milking points; a fourth functioning role wherein the controller is programmed to control a fluid pressure sensor monitoring a pressure level at a second point in the milk line, the set of milking points being located between the first and second points in the milk line and milk extracted via the milking points passing the second point in the milk line before entering a receiver tank configured to temporarily store extracted milk from the milk line before the extracted milk is forwarded to a milk tank; a fifth functioning role wherein the controller is programmed to control a fluid pressure sensor monitoring a pressure level in the receiver tank; a sixth functioning role wherein the controller is programmed to control a fluid pressure sensor monitoring a pressure level in a regulating loop of a pressure regulator of a vacuum pump arranged to provide a system pressure in the milk line; and/or a seventh functioning role wherein the controller is programmed to control a fluid pressure sensor monitoring a pressure level in vacuum level supplied by the vacuum pump. Thereby, the functionalities of all the pressure sensors of a milking plant can be set up from the remote location

According to another embodiment of this aspect of the invention, a first storage resource contains a first database. The first storage resource is communicatively connected to the first server, and the first database, in turn, holds software code representing firmware for at least one of the programmable controllers. Moreover, the first server is configured to obtain the software code representing the firmware for the at least one of the programmable controllers, and forward the software code representing the firmware for the at least one of the programmable controllers to the second server.

In response to receiving the software code representing the firmware for the at least one of the programmable controllers, the second server is configured to transmit a firmware-programming message to the at least one of the programmable controllers. The firmware-programming message contains the software code representing the firmware for the at least one of the programmable controllers. The firmware-programming message is configured to cause the at least one of the programmable controllers to update a current version of its firmware to a firmware version being based on the software code comprised in the firmware-programming message. Consequently, the programmable controllers can be firmware-updated in a very straightforward manner.

According to yet another embodiment of this aspect of the invention, the at least one controller contains at least one first controller assigned to the first functioning role in which the at least one first controller is configured to register pressure-level values at a first repetition frequency, and at least one second controller assigned to the second functioning role in which the at least one second controller is configured to register pressure-level values at a second repetition frequency. Thus, different controllers may be set to measure respective pressure levels at different degrees of temporal resolution. For example, the pressure level in the common milk line may need to be measured at a relatively high repetition frequency, say 1000 Hz, whereas it may be sufficient to measure the vacuum level supplied by the vacuum pump at a relatively low repetition frequency, say 10 Hz.

In another embodiment of this aspect of the invention, the at least one controller includes at least three controllers, and the at least two different functioning roles also contain at least one third controller assigned to a third functioning role in which the at least one third controller is configured to register pressure-level values at a third repetition frequency. Hence, for example, a controller assigned to the third functioning role may measure its values at a mid-repetition frequency, say 100 Hz.

According to still another embodiment of this aspect of the invention, the at least one controller contains a processing unit and a memory unit. The controller is specifically configured to register pressure-level values, store each pressure-level value together with a respective time stamp designating a point in time when the pressure-level value was registered, each pressure-level value is stored in the memory unit. The controller is also configured to forward a set of pressure-level values and time stamps stored in the memory unit to the second server. Thereby, the second server may conveniently compile data from a subset, or all, of the controllers in the milking plant.

According to another embodiment of this aspect of the invention, the second server is further configured to forward the pressure-level values together with a respective identity of the at least one controller that registered the pressure-level value and the respective time stamp to the first server. In response to receiving the set of pressure-level values and time stamps. The first server is configured to store the set of pressure-level values together with the respective identity of the at least one controller that registered the pressure-level value and the respective time stamp in the first storage resource. As a result, the first server may readily compile and monitor pressure data from a multitude of milking plants.

According to yet another embodiment of this aspect of the invention, the system contains a wireless communication link configured to transmit the respective programming message to each of the at least one of the at least one controller on a wireless format. This renders the installation process at the farm very straightforward.

According to another aspect of the invention, the object is achieved by a computer-implemented method, which is performed in at least one processor in first and second servers being communicatively connected to one another, where the second server is arranged at a farm where the milking plant monitoring system is located. The second server is further configured to communicate with at least one controller that is programmable and operatively connected to a respective at least one fluid pressure sensor, and which at least one controller is configured to control the respective at least one fluid pressure sensor. The method involves receiving an instruction message from a user terminal in the first server. The instruction message designates identity data of at least one of the at least one controller and an indication of a specific functioning role of at least two different functioning roles that each of the at least one of the at least one controller shall attain. The at least two different functioning roles include a first functioning role wherein the controller is programmed to control a fluid pressure sensor monitoring a pulsation pressure level, and a second functioning role wherein the controller is programmed to control a fluid pressure sensor monitoring a milking pressure level. The method further involves transmitting, in response to the instruction message, a configuration message from the first server to the second server. The configuration message contains a listing that for each of at least one of the at least one controller indicates the specific role that the controller shall attain. The method also involves transmitting, in response to the configuration message, a respective programming message from the second server to each of the at least one of the at least one controller comprised in said listing. The programming message is configured to cause each of the at least one of the at least one controller to attain the specific role indicated by said listing. The advantages of this method, as well as the preferred embodiments thereof, are apparent from the discussion above with reference to the proposed system.

According to a further aspect of the invention, the object is achieved by a computer program loadable into a non-volatile data carrier communicatively connected to a processing unit. The computer program includes software for executing the above method when the program is run on the processing unit.

According to another aspect of the invention, the object is achieved by a non-volatile data carrier containing the above computer program.

Further advantages, beneficial features and applications of the present invention will be apparent from the following description and the dependent claims.

### BRIEF DESCRIPTION OF THE DRAWINGS

The invention is now to be explained more closely by means of preferred embodiments, which are disclosed as examples, and with reference to the attached drawings.

FIG. 1 illustrates an exemplary milking plant in which the controllers may be configured according to one embodiment of the invention;

FIG. 2 shows an overview of a configuration system according to one embodiment of the invention;

FIG. 3 shows a block diagram of the first server according to one embodiment of the invention;

FIG. 4 shows a block diagram of the second server according to one embodiment of the invention; and

FIG. 5 illustrates, by means of a flow diagram, the general method according to the invention.

### DETAILED DESCRIPTION

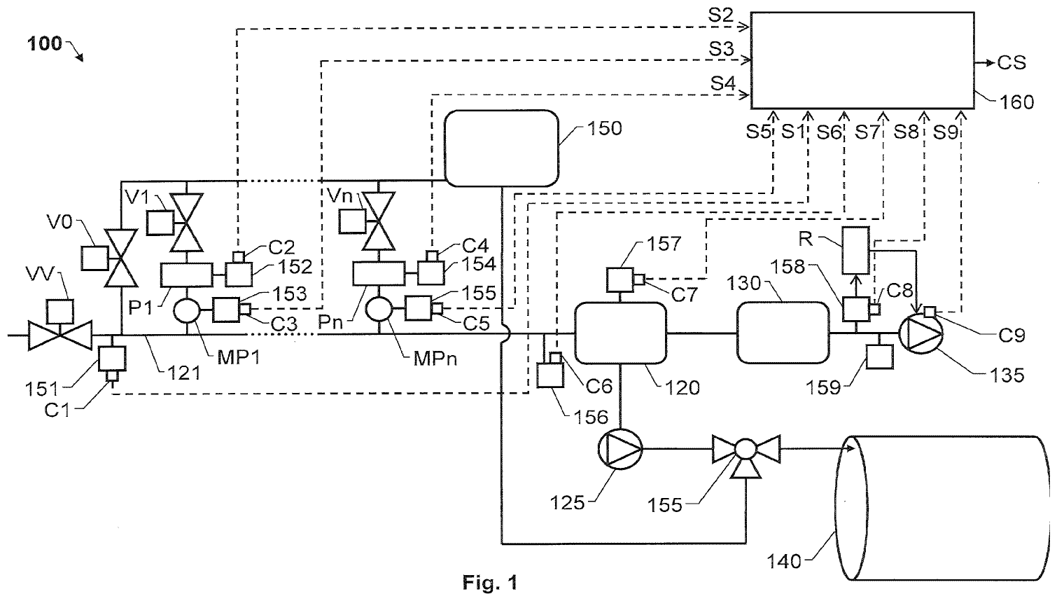

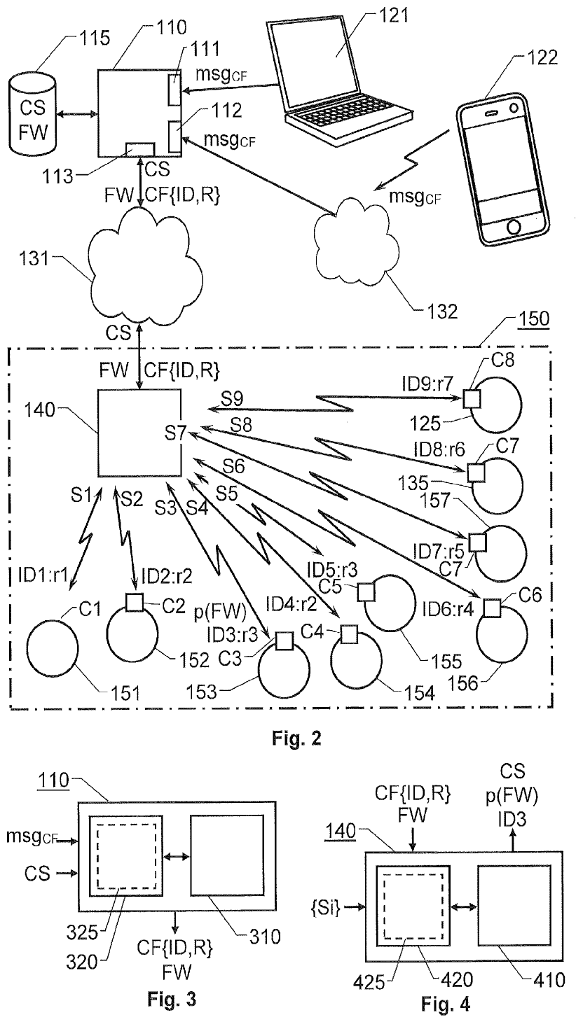

In FIG. 1, we see an example of milking system 100 with a milking plant monitoring system in which the controllers may be configured according to one embodiment of the invention; and in FIG. 2 we see an overview of a configuration system according to one embodiment of the invention.

The milking plant monitoring system includes at least one fluid pressure sensor, exemplified by 125, 135, 151, 152, 153, 154, 155, 156 and 157 respectively in FIGS. 1 and 2. The milking plant monitoring system also includes at least one respective controller, here designated by C1, C2, C3, C4, C5, C6, C7, C8 and C9, that is programmable and operatively connected to the fluid pressure sensors 125, 135, 151, 152, 153, 154, 155, 156 and 157. Each controller C1, C2, C3, C4, C5, C6, C7, C8 and C9 is configured to control the respective fluid pressure sensor to which it is operatively connected.

The configuration system contains first and second servers 110 and 140 respectively. The first and second servers 110 and 140 are interconnected via at least one network 131, e.g. represented by the Internet.

The first server 110 is configured to receive an instruction message msg_{CF} from a user terminal, exemplified by a laptop 121 and a smartphone 122 in FIG. 2. According to the invention, however, the user terminal may be represented by any other type of communication device connectable to the first server 110 via a wired or wireless interface, and possibly over a wireless network 132, which communication device is capable of generating instruction messages msg_{CF} in response to user commands.

The instruction message msg_{CF} designates identity data of at least one of the at least one controller C1, C2, C3, C4, C5, C6, C7, C8 and/or C9. Additionally, the instruction message msg_{CF} designates an indication of a specific functioning role of at least two different functioning roles that each of the at least one of the at least one controller shall attain. The at least two different functioning roles include a first functioning role wherein the controller is programmed to control a fluid pressure sensor monitoring a pulsation pressure level, and a second functioning role wherein the controller is programmed to control a fluid pressure sensor monitoring a milking pressure level.

The second server 140 is communicatively connected to the first server 110 via at the least one network 131. The second server 140 is arranged at a farm 150, where the milking system 100 is located that is monitored by the milking plant monitoring system. The second server 140 is configured to communicate with the at least one controller C1, C2, C3, C4, C5, C6, C7, C8 and C9, e.g. wirelessly.

In addition to the above, the first server 110 is configured to transmit a configuration message CF{ID, R} to the second server 140 in response to receiving the instruction message msg_{CF} from the user terminal 121 or 122. The configuration message CF{ID,R} contains a listing that for each of at least one of the at least one controller C1, C2, C3, C4, C5, C6, C7, C8 and/or C9 indicates the specific role that the controller shall attain.

In response to the configuration message CF{ID,R}, the second server 140 is configured to transmit a respective programming message ID1:r1, ID2:r2, ID3:r3, ID4:r1, ID5:r2, ID6:r2 and/or ID7:r2 to each of the at least one of the at least one controller C1, C2, C3, C4, C5, C6, C7, C8 and/or C9 comprised in listing of the configuration message CF{ID, R}. The programming message ID1:r1, ID2:r2, ID3:r3, ID4:r1, ID5:r2, ID6:r2 and ID7:r2 is configured to cause each of the at least one of the at least one controller C1, C2, C3, C4, C5, C6, C7, C8 and C9 respectively to attain the specific role indicated the listing of the configuration message CF{ID,R}.

According to one embodiment of the invention, the first functioning role involves monitoring the pulsation pressure level in a pulsator, exemplified by 152 and 154, in at least one milking point in the milking system 100 at the farm 150. FIG. 1 illustrates the milking points by reference numerals MP1 and MPn respectively. Typically, the milking system 100 contains a relatively large number of milking points, say 10 to 100, which are installed along a milk line 121. A respective pulsator is arranged at each milking point. For example, to attain adequate measurement accuracy, the pulsation pressure level may be registered at a repetition frequency around 1000 Hz. According to this embodiment, the second functioning role involves monitoring the milking pressure level in the at least one milking point MP1 and MPn of the milking system 100 at the farm 150. For example, for adequate accuracy, the milking pressure level in the at least one milking point MP1 and MPn may be registered at a repetition frequency around 100 Hz.

Specifically, according to one embodiment of the invention, at least one first controller of the controllers C1, C2, C3, C4, C5, C6, C7, C8 and C9 is assigned to the first functioning role. In this role, the at least one first controller is configured to register pressure-level values at a first repetition frequency, say 1000 Hz. This measurement rate is inter alia appropriate for a fluid pressure sensor 151 arranged at a first point in a milk line 121 of the milking system 100, which fluid pressure sensor 151 is configured to measure the characteristics of a washing slug sent through the milk line 121 to clean the same. In this embodiment of the invention, at least one second controller is assigned to the second functioning role in which the at least one second controller is configured to register pressure-level values at a second repetition frequency, say 100 Hz or 10 Hz. A measurement repetition frequency of 100 Hz is suitable for the fluid pressure sensors 153 and 155 arranged to measure a milking vacuum in a milking point MP1 or MPn; whereas a measurement repetition frequency of 10 Hz is suitable for a fluid pressure sensor 158 of a vacuum regulator R.

According to another embodiment of the invention, at least one third controller of the controllers C1, C2, C3, C4, C5, C6, C7, C8 and/or C9 assigned to a third functioning role in which the at least one third controller is configured to register pressure-level values at a third repetition frequency. For example, one or more of the controllers C1, C2, C3, C4, C5, C6, C7, C8 and/or C9 may be assigned to register pressure-level values at 10 Hz, one or more of the controllers C1, C2, C3, C4, C5, C6, C7, C8 and/or C9 may be assigned to register pressure-level values at 100 Hz, and one or more of the controllers C1, C2, C3, C4, C5, C6, C7, C8 and/or C9 may be assigned to register pressure-level values at 1000 Hz.

Preferably, each of the controllers C1, C2, C3, C4, C5, C6, C7, C8 and C9 contains a respective processing unit and memory unit. Further, each of the controllers C1, C2, C3, C4, C5, C6, C7, C8 and C9 is preferably configured to register pressure-level values S1, S2, S3, S4, S5, S6, S7, S8 and S9 respectively; and store each pressure-level value S1, S2, S3, S4, S5, S6, S7, S8 and S9 together with a respective time stamp designating a point in time when the pressure-level value was registered. Each pressure-level value is stored in the memory unit of the respective controller. Additionally, it is advantageous if each of the controllers C1, C2, C3, C4, C5, C6, C7, C8 and C9 is configured to forward a set of pressure-level values and time stamps stored in the memory unit to the second server 140. For example, a controller arranged to monitor the pulsation pressure level in a pulsator, may be programmed to record a set of measurement values representing five pulsation cycles, which set of measurement values is registered at 1000 Hz; and then forward the set of measurement values to the second server 140.

According to one embodiment of the invention, the second server 140, in turn, is configured to forward the pressure-level values S1, S2, S3, S4, S5, S6, S7, S8 and S9 respectively and the associated and time stamps to the first server 110. Naturally, this data is forwarded together with a respective identity of the controller C1, C2, C3, C4, C5, C6, C7, C8 and C9 respectively that registered the pressure-level value in question. In response to receiving the set of pressure-level values S1, S2, S3, S4, S5, S6, S7, S8 and S9 the time stamps and the respective identities, the first server 110 is configured to store the set of pressure-level values S1, S2, S3, S4, S5, S6, S7, S8 and S9 together with the respective identity of the at least one controller C1, C2, C3, C4, C5, C6, C7, C8 and C9 that registered the pressure-level value and the respective time stamp in the first storage resource 115. Consequently, it is possible to study and analyze the functionalities of the fluid pressure sensors in the milking system from a remote location, for instance the first server 110, or any other computing/communication device communicatively connected thereto.

It is preferable that further functioning roles are defined in addition to the above first and second functioning roles.

According to one embodiment of the invention, in a third functioning role the controller C1 is programmed to control a fluid pressure sensor monitoring a pressure level at a first point in the milk line 121 arranged to transport milk from a set of milking points MP1 and MPn.

In a fourth functioning role, the controller C6 is programmed to control a fluid pressure sensor monitoring a pressure level at a second point in the milk line 121. The first and second points are arranged in the milk line 121 such that the set of milking points MP1 and MPn are located between the first and second points. Moreover, the second point is arranged in the milk line 121 such that the milk that is extracted via the milking points MP1 and MPn pass the second point in the milk line 121 before entering into a receiver tank 120, which is configured to temporarily store extracted milk from the milk line 121 before the extracted milk is forwarded to a milk tank 140.

In a fifth functioning role, the controller C7 is programmed to control a fluid pressure sensor monitoring a pressure level in the receiver tank 120.

In a sixth functioning role, the controller C8 is programmed to control a fluid pressure sensor monitoring a pressure level in a regulating loop of a pressure regulator R of a vacuum pump 135 arranged to provide a system pressure in the milk line 121.

In a seventh functioning role, the controller C9 is programmed to control a fluid pressure sensor monitoring a pressure level in vacuum level supplied by the vacuum pump 135.

The configuration system may include a first storage resource 115 containing a first database, which first storage resource 115 is communicatively connected to the first server 110. The first database, in turn, contains software code representing firmware FW for at least one of the programmable controllers C1, C2, C3, C4, C5, C6, C7, C8 and/or C9. Thereby, the first server 110 may obtain the software code representing the firmware FW for the at least one of the programmable controllers C1, C2, C3, C4, C5, C6, C7, C8 and/or C9 and forward the software code representing the firmware FW for the at least one of the programmable controllers C1, C2, C3, C4, C5, C6, C7, C8 and/or C9 to the second server 140.

In response to receiving the software code representing the firmware FW for the at least one of the programmable controllers C1, C2, C3, C4, C5, C6, C7, C8 and/or C9, the second server 140 is configured to transmit a firmware-programming message p(FW) to the at least one of the programmable controllers C1, C2, C3, C4, C5, C6, C7, C8 and/or C9, for example over a wireless link implemented according to the Bluetooth standard. The firmware-programming message, e.g. ID3:r3 directed to the programmable controllers C3 and C5, contains the software code representing the firmware FW for these programmable controllers C3 and C5. The firmware-programming message p(FW) is configured to cause the programmable controllers C3 and C5 to update a current version of their respective firmware to a firmware version being based on the software code comprised in the firmware-programming message p(FW). Thus, it is rendered straightforward to gradually improve and adjust the functionality of all the programmable controllers C1, C2, C3, C4, C5, C6, C7, C8 and C9, for example via manual or automatic control commands entered into the first server 110.

Naturally, the above-mentioned wireless communication link may be configured to transmit respective programming message ID1:r1, ID2:r2, ID3:r3, ID4:r1, ID5:r2, ID6:r2 and/or ID7:r2 to the controllers C1, C2, C3, C4, C5, C6, C7, C8 and/or C9 on a wireless format, which programming message ID1:r1, ID2:r2, ID3:r3, ID4:r1, ID5:r2, ID6:r2 and/or ID7:r2 are configured to assign the specific functioning role to the controllers C1, C2, C3, C4, C5, C6, C7, C8 and/or C9.

FIG. 3 shows a block diagram of the first server 110 according to one embodiment of the invention. It is generally advantageous if the first server 110 is configured to effect the above-described procedure in conjunction with the second server 140 in an automatic manner by executing a first computer program 325. Therefore, the first server 110 may include a first memory unit 320, i.e. non-volatile data carrier, storing the first computer program 325, which, in turn, contains software for making processing circuitry in the form of at least one first processor 310 in the first server 110 execute the actions mentioned in this disclosure when the first computer program 325 is run on the at least one first processor 310.

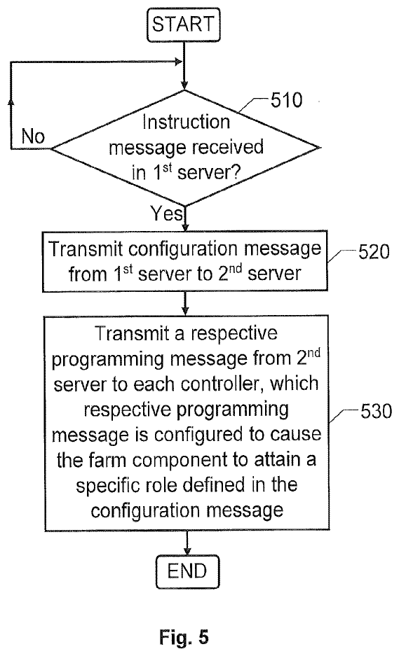

FIG. 4 shows a block diagram of the second server 140 according to one embodiment of the invention. Analogous to the above, it is generally advantageous if the second server 140 is configured to effect the above-described procedure in conjunction with the first server 110 in an automatic manner by executing a second computer program 425. Therefore, the second server 140 may include a second memory unit 420, i.e. non-volatile data carrier, storing the second computer program 425, which, in turn, contains software for making processing circuitry in the form of at least one second processor 410 in the second server 140 execute the actions mentioned in this disclosure when the second computer program 425 is run on the at least one second processor 410. In order to sum up, and with reference to the flow diagram in FIG. 5, we will now describe the computer-implemented method according to the invention which is performed in the first and second servers 110 and 140 respectively.

A first step 510 checks if a an instruction message msg_{CF} from a user terminal has been received in the first server 110. If so, a step 520 follows; and otherwise, the procedure loops back and stays in step 510. The instruction message msg_{CF} designates identity data of at least one of the at least one controller C1, C2, C3, C4, C5, C6, C7, C8, and/or C9; and an indication of a specific functioning role of at least two different functioning roles that each of the at least one of the at least one controller shall attain.

In step 520, a configuration message CF{ID, R} is transmitted from the first server 110 to the second server 140. The configuration message CF{ID, R} contains a listing that for each of at least one of the controllers C1, C2, C3, C4, C5, C6, C7, C8 and/or C9 indicates the specific role that the controller shall attain.

Thereafter, in a step 530, the second server 140 transmits, a respective programming message ID1:r1, ID2:r2, ID3:r3, ID4:r1, ID5:r2, ID6:r2 and/or ID7:r2 to each of the at least one of the at least one controller C1, C2, C3, C4, C5, C6, C7, C8 and/or C9 included in listing of the configuration message CF{ID,R}. The programming message is configured to cause each of the at least one of the at least one controller to attain the specific role indicated by said listing.

The process steps described with reference to FIG. 5 may be controlled by means of a programmed processor. Moreover, although the embodiments of the invention described above with reference to the drawings comprise processor and processes performed in at least one processor, the invention thus also extends to computer programs, particularly computer programs on or in a carrier, adapted for putting the invention into practice. The program may be in the form of source code, object code, a code intermediate source and object code such as in partially compiled form, or in any other form suitable for use in the implementation of the process according to the invention. The program may either be a part of an operating system, or be a separate application. The carrier may be any entity or device capable of carrying the program. For example, the carrier may comprise a storage medium, such as a Flash memory, a ROM (Read Only Memory), for example a DVD (Digital Video/Versatile Disk), a CD (Compact Disc) or a semiconductor ROM, an EPROM (Erasable Programmable Read-Only Memory), an EEPROM (Electrically Erasable Programmable Read-Only Memory), or a magnetic recording medium, for example a floppy disc or hard disc. Further, the carrier may be a transmissible carrier such as an electrical or optical signal which may be conveyed via electrical or optical cable or by radio or by other means. When the program is embodied in a signal, which may be conveyed, directly by a cable or other device or means, the carrier may be constituted by such cable or device or means. Alternatively, the carrier may be an integrated circuit in which the program is embedded, the integrated circuit being adapted for performing, or for use in the performance of, the relevant processes.

Variations to the disclosed embodiments can be understood and effected by those skilled in the art in practicing the claimed invention, from a study of the drawings, the disclosure, and the appended claims.

The term “comprises/comprising” when used in this specification is taken to specify the presence of stated features, integers, steps or components. The term does not preclude the presence or addition of one or more additional elements, features, integers, steps or components or groups thereof. The indefinite article “a” or “an” does not exclude a plurality. In the claims, the word “or” is not to be interpreted as an exclusive or (sometimes referred to as “XOR”). On the contrary, expressions such as “A or B” covers all the cases “A and not B”, “B and not A” and “A and B”, unless otherwise indicated. The mere fact that certain measures are recited in mutually different dependent claims does not indicate that a combination of these measures cannot be used to advantage. Any reference signs in the claims should not be construed as limiting the scope.

It is also to be noted that features from the various embodiments described herein may freely be combined, unless it is explicitly stated that such a combination would be unsuitable.

The invention is not restricted to the described embodiments in the figures, but may be varied freely within the scope of the claims.

1. A configuration system for a milking plant monitoring system comprising at least one fluid pressure sensor (125, 135, 151, 152, 153, 154, 155, 156, 157) and at least one respective controller (C1, C2, C3, C4, C5, C6, C7, C8, C9) that is programmable and operatively connected to the at least one fluid pressure sensor and configured to control the at least one fluid pressure sensor, the configuration system comprising:
a first server (110) configured to receive an instruction message (msg_{CF}) from at least one user terminal (121, 122), the instruction message (msg_{CF}) comprising:
identity data of at least one of the at least one controller (C1, C2, C3, C4, C5, C6, C7, C8, C9), and
an indication of a specific functioning role of at least two different functioning roles that each of the at least one of the at least one controller is configured to perform, the at least two different functioning roles comprising:
a first functioning role wherein the controller is programmed to control a fluid pressure sensor monitoring a pulsation pressure level, and
a second functioning role wherein the controller is programmed to control a fluid pressure sensor monitoring a milking pressure level; and
a second server (140) communicatively connected to the first server (110), the second server (140) being arranged at a farm (150) comprising the milking plant monitoring system, the second server (140) being configured to communicate with the at least one controller (C1, C2, C3, C4, C5, C6, C7, C8, C9), the first server (110) being configured to:
transmit a configuration message (CF{ID,R}) to the second server (140) in response to receiving the instruction message (msg_{CF}), the configuration message (CF{ID,R}) comprising a listing that for each of at least one of the at least one controller (C1, C2, C3, C4, C5, C6, C7, C8, C9) indicates the specific functioning role that the controller is configured to perform; and in response to the configuration message (CF{ID,R}), the second server (140) is configured to:
transmit a respective programming message (ID1:r1, ID2:12, ID3:r3, ID4:r1, ID5:12, ID6:12; ID7:r2) to each of the at least one of the at least one controller (C1, C2, C3, C4, C5, C6, C7, C8, C9) comprised in said listing, the programming message being configured to cause each of the at least one of the at least one controller to be configured to perform the specific functioning role indicated by said listing.

2. The configuration system according to claim 1, wherein:
the first functioning role comprises monitoring the pulsation pressure level in a pulsator (152, 154) in at least one milking point (MP1, MPn) in a milking system (100) at the farm (150), the milking system (100) being monitored by the milking plant monitoring system; and
the second functioning role comprises monitoring the milking pressure level in the at least one milking point (MP1, MPn) of the milking system (100) at the farm (150).

3. The configuration system according to claim 2, wherein the at least two different functioning roles further comprise one of at least:
a third functioning role wherein the controller (C1) is programmed to control a fluid pressure sensor monitoring a pressure level at a first point in a milk line (121) arranged to transport milk from a set of said at least one milking point (MP1, MPn);
a fourth functioning role wherein the controller (C6) is programmed to control a fluid pressure sensor monitoring a pressure level at a second point in the milk line (121), the set of milking points (MP1, MPn) being located between the first and second points in the milk line (121) and milk extracted via the milking points (MP1, MPn) passing the second point in the milk line (121) before entering a receiver tank (120) configured to temporarily store extracted said milk from the milk line (121) before the extracted milk is forwarded to a milk tank (140);
a fifth functioning role wherein the controller (C7) is programmed to control a fluid pressure sensor monitoring a pressure level in the receiver tank (120);
a sixth functioning role wherein the controller (C8) is programmed to control a fluid pressure sensor monitoring a pressure level in a e of a pressure regulator (R) of a vacuum pump (135) arranged to provide a system pressure in the milk line (121); and
a seventh functioning role wherein the controller (C9) is programmed to control a fluid pressure sensor monitoring a pressure level in vacuum level supplied by the vacuum pump (135).

4. The configuration system according to claim 1, further comprising a first storage resource (115) comprising a first database, the first storage resource (115) being communicatively connected to the first server (110), the first database comprising software code representing firmware (FW) for at least one of the programmable controllers (C1, C2, C3, C4, C5, C6, C7, C8, C9), and the first server (110) is further configured to:
obtain the software code representing the firmware (FW) for the at least one of the programmable controllers (C1, C2, C3, C4, C5, C6, C7, C8, C9), and
forward the software code representing the firmware (FW) for the at least one of the programmable controllers (C1, C2, C3, C4, C5, C6, C7, C8, C9) to the second server (140).

5. The configuration system according to claim 4, wherein, in response to receiving the software code representing the firmware (FW) for the at least one of the programmable controllers (C1, C2, C3, C4, C5, C6, C7, C8, C9), the second server (140) is configured to:
transmit a firmware-programming message (p(FW)) to the at least one of the programmable controllers (C1, C2, C3, C4, C5, C6, C7, C8, C9), the firmware-programming message (ID3:r3) comprising the software code representing the firmware (FW) for the at least one of the programmable controllers (C3, C5), and the firmware-programming message (p(FW)) being configured to cause the at least one of the programmable controllers (C3, C5) to update a current version of the at least one of the programmable controllers' firmware to a firmware version that is based on the software code comprised in the firmware-programming message (p(FW)).

6. The configuration system according to claim 1, wherein the at least one controller (C1, C2, C3, C4, C5, C6, C7, C8, C9) comprises:
at least one first controller assigned to the first functioning role in which the at least one first controller is configured to register pressure-level values at a first repetition frequency, and
at least one second controller assigned to the second functioning role in which the at least one second controller is configured to register pressure-level values at a second repetition frequency.

7. The configuration system according to claim 6, wherein the at least one controller (C1, C2, C3, C4, C5, C6, C7, C8, C9) comprises at least three controllers, and the at least two different functioning roles comprises:
at least one third controller assigned to a third functioning role in which the at least one third controller is configured to register pressure-level values at a third repetition frequency.

8. The configuration system according to claim 1, wherein the at least one controller (C1, C2, C3, C4, C5, C6, C7, C8, C9) comprises a processing unit and a memory unit, and the controller is configured to:
register pressure-level values (S1, S2, S3, S4, S5, S6, S7, S8, S9),
store each of the pressure-level values (S1, S2, S3, S4, S5, S6, S7, S8, S9) together with a respective time stamp designating a point in time when the pressure-level value was registered, each said pressure-level value being stored in the memory unit, and
forward a set of said pressure-level values and said time stamps stored in the memory unit to the second server (140).

9. The configuration system according to claim 8, wherein
the second server (140) is configured to forward the pressure-level values (S1, S2, S3, S4, S5, S6, S7, S8, S9) together with a respective identity of the at least one controller (C1, C2, C3, C4, C5, C6, C7, C8, C9) that registered the pressure-level value and the respective time stamp to the first server (110), and in response to receiving the set of pressure-level values (S1, S2, S3, S4, S5, S6, S7, S8, S9) and said time stamps
the first server (110) is configured to store the set of pressure-level values (S1, S2, S3, S4, S5, S6, S7, S8, S9) together with the respective identity of the at least one controller (C1, C2, C3, C4, C5, C6, C7, C8, C9) that registered the pressure-level value and the respective time stamp in the first storage resource (115).

10. The configuration system according to claim 1, further comprising:
a wireless communication link configured to transmit the respective programming message (ID1:r1, ID2:12, ID3:r3, ID4:r1, ID5:12, ID6:12; ID7:r2) to each of the at least one of the at least one controller (C1, C2, C3, C4, C5, C6, C7, C8, C9) on a wireless format.

11. A computer-implemented method for configuring a milking plant monitoring system, which method is performed in at least one processor in first and second servers (110; 140) being communicatively connected to one another, the second server (140) being arranged at a farm (150) comprising the milking plant monitoring system, and the second server (140) being further configured to communicate with at least one controller (C1, C2, C3, C4, C5, C6, C7, C8, C9) that is programmable and operatively connected to a respective at least one fluid pressure sensor (125, 135, 151, 152, 153, 154, 155, 156, 157), which at least one controller (C1, C2, C3, C4, C5, C6, C7, C8, C9) is configured to control the respective at least one fluid pressure sensor, the method comprising:
receiving an instruction message (msg_{CF}) from a user terminal (121, 122) in the first server (110), the instruction message (msg_{CF}) comprising:
identity data of at least one of the at least one controller (C1, C2, C3, C4, C5, C6, C7, C8, C9), and
an indication of a specific functioning role of at least two different functioning roles that each of the at least one of the at least one controller is configured to perform, the at least two different functioning roles comprising:
a first functioning role wherein the controller is programmed to control a fluid pressure sensor monitoring a pulsation pressure level, and
a second functioning role wherein the controller is programmed to control a fluid pressure sensor monitoring a milking pressure level; and
transmitting, in response to the instruction message (msg_{CF}), a configuration message (CF{ID,R}) from the first server (110) to the second server (140), which configuration message (CF{ID,R}) comprises a listing that for each of at least one of the at least one controller (C1, C2, C3, C4, C5, C6, C7, C8, C9) indicates a specific said functioning role that the controller is configured to perform;
transmitting, in response to the configuration message (CF{ID,R}), a respective programming message (ID1:r1, ID2:r2, ID3:r3, ID4:r1, ID5:12, ID6:12; ID7:r2) from the second server (140) to each of the at least one of the at least one controller (C1, C2, C3, C4, C5, C6, C7, C8, C9) comprised in said listing, the programming message being configured to cause each of the at least one of the at least one controller to perform the specific functioning role indicated by said listing.

12. The method according to claim 11, wherein
the first functioning role comprises monitoring the pulsation pressure level in a pulsator (152, 154) in at least one milking point (MP1, MPn) in a milking system (100) at the farm (150), the milking system (100) being monitored by the milking plant monitoring system; and
the second functioning role comprises monitoring the milking pressure level in the at least one milking point (MP1, MPn) of the milking system (100) at the farm (150).

13. The method according to claim 12, wherein the at least two different functioning roles further comprise one of at least:
a third functioning role wherein the controller (C1) is programmed to control a fluid pressure sensor monitoring a pressure level at a first point in a milk line (121) arranged to transport milk from a set of said at least one milking point (MP1, MPn);
a fourth functioning role wherein the controller (C6) is programmed to control a fluid pressure sensor monitoring a pressure level at a second point in the milk line (121), the set of milking points (MP1, MPn) being located between the first and second points in the milk line (121) and milk extracted via the milking points (MP1, MPn) passing the second point in the milk line (121) before entering a receiver tank (120) configured to temporarily store extracted milk from the milk line (121) before the extracted said milk is forwarded to a milk tank (140);
a fifth functioning role wherein the controller (C7) is programmed to control a fluid pressure sensor monitoring a pressure level in the receiver tank (120);
a sixth functioning role wherein the controller (C8) is programmed to control a fluid pressure sensor monitoring a pressure level in a pressure regulator (R) of a vacuum pump (135) arranged to provide a system pressure in the milk line (121); and
a seventh functioning role wherein the controller (C9) is programmed to control a fluid pressure sensor monitoring a pressure level in the vacuum pump (135).

14. The method according to claim 13, further comprising:
obtaining, in the first server (110), software code from a first database comprised in a first storage resource (115), the software code representing firmware (FW) for at least one of the controllers (C1, C2, C3, C4, C5, C6, C7, C8, C9), and
forwarding, from the first server (110), the software code representing the firmware (FW) for the at least one of the programmable controllers (C1, C2, C3, C4, C5, C6, C7, C8, C9) to the second server (140).

15. The method according to claim 14, further comprising:
transmitting, from the second server (140), a firmware-programming message (p(FW)) to the at least one of the programmable controllers (C1, C2, C3, C4, C5, C6, C7, C8, C9) in response to the software code representing the firmware (FW) for the at least one of the programmable controllers (C1, C2, C3, C4, C5, C6, C7, C8, C9), the firmware-programming message (ID3:r3) comprising the software code representing the firmware (FW) for the at least one of the programmable controllers (C3, C5), and the firmware-programming message (p(FW)) being configured to cause the at least one of the programmable controllers (C3, C5) to update a current version of the at least one of the programmable controllers' firmware to a firmware version being based on the software code comprised in the firmware-programming message (p(FW)).

16. The method according to claim 11, wherein the at least one controller (C1, C2, C3, C4, C5, C6, C7, C8, C9) comprises:
at least one first controller assigned to the first functioning role in which the at least one first controller is configured to register pressure-level values at a first repetition frequency, and
at least one second controller assigned to the second functioning role in which the at least one second controller is configured to register pressure-level values at a second repetition frequency.

17. The method according to claim 16, wherein the at least one controller (C1, C2, C3, C4, C5, C6, C7, C8, C9) comprises at least three controllers, and the at least two different functioning roles comprises:
at least one third controller assigned to a third functioning role in which the at least one third controller is configured to register pressure-level values at a third repetition frequency.

18. The method according to claim 11, further comprising:
registering pressure-level values (S1, S2, S3, S4, S5, S6, S7, S8, S9) by the at least one controller (C1, C2, C3, C4, C5, C6, C7, C8, C9),
storing each of the pressure-level values (S1, S2, S3, S4, S5, S6, S7, S8, S9) together with a respective time stamp designating a point in time when the pressure-level value was registered in a memory unit in the respective at least one controller (C1, C2, C3, C4, C5, C6, C7, C8, C9), and
forwarding a set of said pressure-level values and said time stamps stored in the memory unit from the respective at least one controller (C1, C2, C3, C4, C5, C6, C7, C8, C9) to the second server (140).

19. The method according to claim 18, further comprising:
forwarding, from the second server (140), the pressure-level values (S1, S2, S3, S4, S5, S6, S7, S8, S9) together with a respective identity of the at least one controller (C1, C2, C3, C4, C5, C6, C7, C8, C9) that registered the pressure-level value and the respective time stamp to the first server (110), and in response to receiving the set of pressure-level values (S1, S2, S3, S4, S5, S6, S7) and said time stamps, and
storing, in the first server (110), the set of pressure-level values (S1, S2, S3, S4, S5, S6, S7, S8, S9) together with the respective identity of the at least one controller (C1, C2, C3, C4, C5, C6, C7, C8, C9) that registered the pressure-level value and the respective time stamp in the first storage resource (115).

20. The method according to claim 11, comprising:
transmitting the respective programming message (ID1:r1, ID2:12, ID3:r3, ID4:r1, ID5:r2, ID6:12; ID7:r2) to each of the at least one of the at least one controller (C1, C2, C3, C4, C5, C6, C7, C8, C9) on a wireless format over a wireless communication link.

21. A non-transitory computer-readable medium on which is stored a computer program comprising software for executing the method according claim 11 when the computer program (325; 425) is run on a processing unit (310; 410).

22. (canceled)
